(19) United States
(12) Patent Application Publication
(10) Pub. No.: US 2002/0053381 A1
(43) Pub. Date: May 9, 2002

(54) Vehicle tire

(75) Inventor: Matthias Hartwig, Hannover (DE)

Correspondence Address: GREENBLUM & BERNSTEIN, P.L.C., 1941 ROLAND CLARKE PLACE, RESTON, VA, 20191, US

(73) Assignee: CONTINENTAL AG, Hanover (DE)

(21) Appl. No.: 09/985,496

(22) Filed: Nov. 5, 2001

(30) Foreign Application Priority Data
Nov. 4, 2000 (DE) 100 54 694.3

(51) Int. Cl. B60C 11/00

(52) U.S. Cl. 152/209.8; 152/209.16

(57) ABSTRACT

Vehicle tire comprises a rubber tread profile, and at least one rubber tread area running in a circumferential direction. Primary profile structures are arranged in the rubber tread area, the primary profile structures being aligned at an angle deviating up to 40° from the circumferential direction. Secondary profile structures are provided in a crossing arrangement in relation to the primary profile structures, wherein the primary and the secondary profile structures form similar pitches of differing circumferential lengths in the circumferential direction. At least two types of base pitches are provided, a first of the at least two types of base pitches differing from a second of the at least two types of base pitches by their various circumferential lengths. The base pitches of one type are identically embodied, whereas the base pitches are embodied differently relative to the progression of their profile structures. Each base pitch completely encircles one of the primary profile structures and divides secondary pitch structures at pitch limits, each running for given mutual distances.

### CROSS-REFERENCE TO RELATED APPLICATIONS

The present application claims priority under 35 U.S.C. §119 of German Patent Application No. 100 54 694.3, filed on Nov. 4, 2000, the disclosure of which is expressly incorporated by reference herein in its entirety.

### BACKGROUND OF THE INVENTION

1. Field of the Invention

The invention relates to a vehicle tire with a rubber tread profile having at least one rubber tread area rotating in the circumferential direction with primary profile structures being provided therein, e.g., ribs or grooves, aligned at an angle deviating from the circumferential direction by up to 40°, and secondary profile structures being provided in a crosswise arrangement in relation to the primary profile structures, in particular, transverse notches, with the primary and the secondary profile structures forming similar pitches, following one another in the circumferential direction and having different circumferential lengths.

2. Discussion of Background Information

Rubber tread profiles of the type mentioned above are known in various embodiments, particularly for car tires. The primary profile structures may be grooves tilted at a comparatively small angle of 20°, for example, in relation to the circumferential direction, and may extend over a rubber tread area, of a rubber tread half. These grooves may be combined with transverse notches that form the secondary profile structures in a crosswise arrangement, where each groove can be crossed by a number of transverse notches. However, the transverse notches may also run into the grooves without crossing them.

In order to reduce the tire/road noise and to subjectively optimize the same, it is customary to design rubber tread profiles of vehicle tires such that they are composed of identically embodied profile sections (so-called pitches) provided in various circumferential lengths in a certain sequence over the tire circumference. Usually, three to five different circumferential lengths are selected for such pitches with their maximal length ratio to one another being predetermined and/or preset, and with their most advantageous sequence being ascertainable by means of corresponding calculation programs. Here, depending on the profile design or the intended use of the vehicle tire it is also customary to provide different pitch sequences and differently embodied pitches in different rubber tread areas on the very same tire. In patent publications a multitude of suggested solutions can be found on the subject of optimizing the arrangement of pitches and on the subject of pitch sequences. In this regard, reference is made to EP-A-0 475 929, EP-A-0 454 658, and DE-A-34 450 41.

The division into similar profile sections, of a rubber tread profile of the type mentioned at the outset, in order to achieve an advantageous arrangement thereof in terms of noise, is problematical. In the conventional way of setting pitch limits it is unavoidable for either the primary profile structures or the secondary profile structures to become distorted, or that a shift of profile structures disturbing the optical effect and function has to be accepted.

For this reason the fundamental possibility of pitching the profile without any regularities, is not taken into consideration, because putting it into practice, i.e., creating the mold drawings, making the tire molds, would be extremely expensive and not economical.

### SUMMARY OF THE INVENTION

The invention is based on rendering possible, with a rubber tread profile of the type mentioned at the outset, a division of the profile into similar pitches that can be repeated over the circumference, a division that is favorable in terms of tire/road noise, whereby the realization should be possible at justifiable and, in particular even low cost.

The given object is attained according to the invention by providing for at least two types of base pitches that differ from one another because of different circumferential lengths, and the base pitches belonging to one type constructed congruently, yet differently regarding the progression of their profile structures, where each base pitch includes one each of the primary profile structures and divides secondary profile structures that each run at certain reciprocal intervals, at pitch limits.

According to the invention, the rubber tread can be divided into profile sections of different circumferential lengths that render it possible to easily determine a sequence of these profile sections that is advantageous with respect to noise. Due to the limited number of reciprocal intervals of the secondary profile structures, divided at pitch limit sections, a certain number of different profile sections is determined. It is thus possible to determine an advantageous pitch sequence from a limited number of different pitches, also for rubber tread profiles of the type mentioned at the outset, without distortion of the profile structures, so that a simple construction of mold drawings and, subsequently, the economical production of the corresponding tire molds can be ensured.

The progression of the pitch limits is preferably selected such that, among the secondary profile sections, at least two are divided at a pitch limit section facing the tread center and at least two at a pitch limit section facing the rubber tread edge. This gives the individual base pitches a very distinct and characteristic shape and renders possible a certain sequencing of the base pitches.

In order to limit the required number of different base pitches and, thus, also the combinations of their sequences over the circumference of the tire to a manageable level, the arrangement and the progression of the secondary profile structures are preferably made according to a specific pattern, in which the reciprocal interval of the secondary profile structures divided at the pitch limit section facing the rubber tread center, is each selected consistently within a type of base pitches.

Subsequently, care is taken that the reciprocal interval and/or the reciprocal intervals of the secondary profile structures divided at the pitch limit section facing the rubber tread edge in the pitches of one type of base pitches is and/or are different, but corresponds with at least one type of reciprocal interval and/or reciprocal intervals of the secondary profile structures that are divided at the pitch limit section facing the rubber tread center. This allows for distinct possibilities for sequencing base pitches, whereby through a respective adjustment of the intervals of the secondary profile structures, care can be taken that base pitches are excluded that follow in a disadvantageous and/or undesired way.

Another measure according to the invention that is advantageous for the development of a beneficial tire/road noise, consists of the pitches belonging to one type of base pitch being identically divided into two partial pitches.

In a particularly clear, simple, and yet very effective manner, according to the invention, a profile type can be divided in which the primary profile structures are grooves and the secondary profile structures are transverse notches with, from the circumferential direction, one transverse notch each crosses the two grooves, following one another in the circumferential direction, alternating with a transverse notch that crosses one groove each.

According to the invention, a vehicle tire comprises a rubber tread profile and at least one rubber tread area running in a circumferential direction. Primary profile structures are arranged in the rubber tread area, the primary profile structures being aligned at an angle deviating up to 40° from the circumferential direction. Secondary profile structures are provided in a crossing arrangement in relation to the primary profile structures, wherein the primary and the secondary profile structures form similar pitches of differing circumferential lengths in the circumferential direction. At least two types of base pitches are provided, a first of the at least two types of base pitches differing from a second of the at least two types of base pitches by their various circumferential lengths. The base pitches of one type are identically embodied, whereas the base pitches are embodied differently relative to the progression of their profile structures. Each base pitch completely encircles one of the primary profile structures and divides secondary pitch structures at pitch limits, each running for given mutual distances.

According to another aspect of the invention, the primary profiles may comprise one of ribs and grooves. The secondary profiles may comprise transverse notches.

According to yet another aspect of the invention, the rubber tread may have a center and an edge, at least two of the secondary profile structures being divided at a pitch limit section facing the center of the rubber tread, and at least two of the secondary profile structures being divided at the pitch limit section facing the rubber tread edge.

Furthermore, a reciprocal interval of at least one of the pitch limit sections facing the rubber tread center of the divided secondary profile structures may be identical within one type of base pitches.

Moreover, a reciprocal interval of at least one of the secondary profile structures divided at a pitch limit section facing the rubber tread edge may be different from the pitch of one type of base pitches, but at least consistent with at least one type of reciprocal interval of the secondary profile structures that are divided at the pitch limit section facing the rubber tread center.

Further, according to the invention, the pitches belonging to one type of base pitches may be divided into two partial pitches, each in a consistent way. The primary profile structures may comprise grooves and the secondary profile structures may comprise transverse notches, wherein, from a circumferential direction, one transverse notch crosses two grooves following one another in the circumferential direction, alternating with a transverse notch that crosses each groove.

According to yet another aspect of the invention, a vehicle tire comprises a rubber tread profile, at least one rubber tread area running in a circumferential direction, primary profile structures comprising one of ribs and grooves, the primary profile structures being arranged in the rubber tread area, and being aligned at an angle deviating up to 40° from the circumferential direction. Secondary profile structures comprise transverse notches provided in a crossing arrangement in relation to the primary profile structures, wherein the primary and the secondary profile structures form similar pitches of differing circumferential lengths in the circumferential direction. At least two types of base pitches are provided, a first of the at least two types of base pitches differing from a second of the at least two types of base pitches by their various circumferential lengths. The base pitches of one type are identically embodied, whereas the base pitches are embodied differently relative to the progression of their profile structures. Each base pitch completely encircles one of the primary profile structures and divides secondary pitch structures at pitch limits, each running for given mutual distances. The rubber tread has a center and an edge, at least two of the secondary profile structures being divided at a pitch limit section facing the center of the rubber tread, and at least two of the secondary profile structures being divided at the pitch limit section facing the rubber tread edge. A reciprocal interval of at least one of the pitch limit sections facing the rubber tread center of the divided secondary profile structures is identical within one type of base pitches. A reciprocal interval of at least one of the secondary profile structures divided at a pitch limit section facing the rubber tread edge is different from the pitch of one type of base pitches, but at least consistent with at least one type of reciprocal interval of the secondary profile structures that are divided at the pitch limit section facing the rubber tread center. The pitches belonging to one type of base pitches are divided into two partial pitches, each in a consistent way. One transverse notch, from a circumferential direction, crosses two grooves following one another in the circumferential direction, alternating with a transverse notch that crosses each groove.

Additional features, advantages, and details of the invention are explained in greater detail using the following drawings which show schematically an exemplary embodiment of the invention.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1 illustrates a top view of a partial layout of a rubber tread profile embodied according to the invention; and

FIGS. 2 to 5 illustrate top views of profile sections (pitches)of similar types, however, embodied differently in some dimensions.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

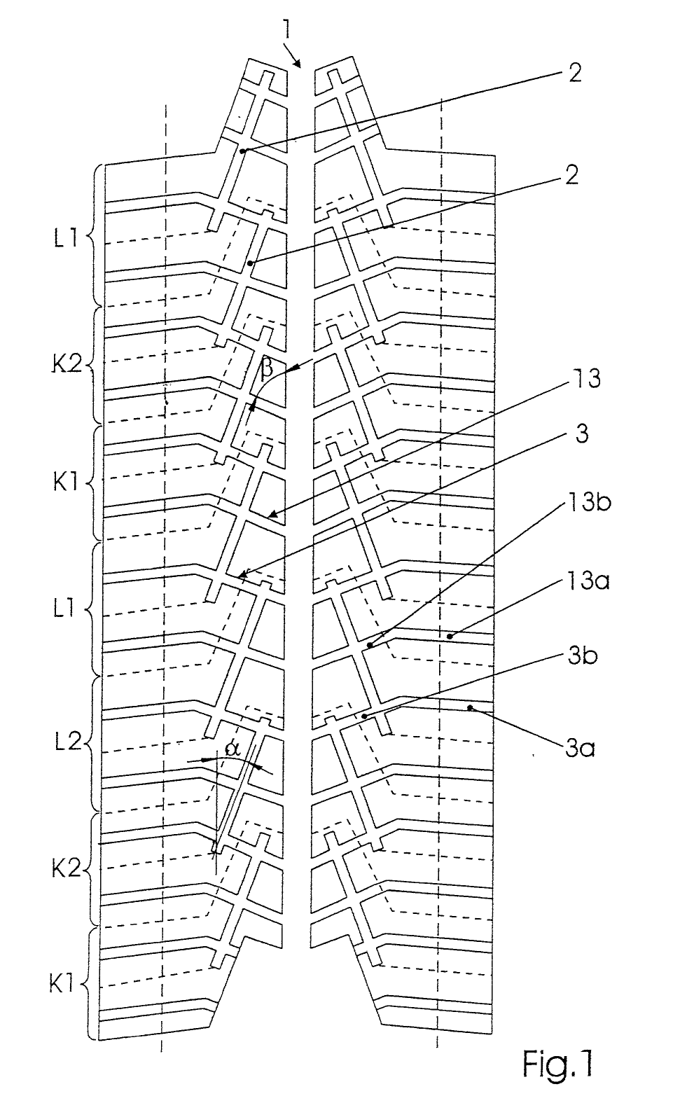

The invention relates to a certain type of sequence and embodiment of pitches, profile sections repeating over the circumference of the rubber tread and embodied similarly, for certain types of rubber tread profiles. FIG. 1 schematically shows one of the potential variants of this type. The rubber tread profile shown, which is particularly suitable for car tires, features a centrally mean circumferential notch 1, to which identically embodied rubber tread areas are linked at both sides, each extending beyond the rubber tread edge marked with a broken line, which forms the lateral limit for the contact surface of the tire with such a profile under normal conditions (nominal pressure, nominal load, standard rim). Due to the congruent embodiment of the two rubber tread areas adjacent to the central circumferential notch 1, the following description refers primarily to the rubber tread area running on the left next to the circumferential notch 1 in FIG. 1.

The crossing arrangement of two profile structures that can be ribs or grooves and/or notches is characteristic of the type of rubber tread profiles mentioned, where one of the profile structures may be aligned at an angle α being no more than about 40° to the circumferential direction. In the embodiment shown, these profile structures are grooves 2, inclined at an acute angle α of approximately 20° to the circumferential direction; the profile structures crossing them are transverse notches 3, 13. The grooves 2 mark the profile structure in the central area of the rubber tread, featuring a length of about 6 cm to about 10 cm, with all grooves 2 having at least essentially the same length for a particular profile. The grooves 2 end at a short distance from the circumferential channel 1 and reach slightly beyond the center of the respective rubber tread area. Transverse notches 3 and 13 alternatively cross the grooves 2, with, in the embodiment shown, each transverse notch 3 crossing two grooves 2, adjacent in the circumferential direction, and each transverse notch 13 crosses only one groove 2 each running in the circumferential direction between adjacent transverse notches 3.

The transverse notches 3, 13, which run essentially parallel to one another, each feature two sections 3a, 3b, 13a, 13b, of which sections 3b, 13b—starting from the central circumferential notch 1—run in the opposite direction to the grooves 2 at an angle β of approximately 70° to the circumferential direction, are bent at the level of the ends of the grooves 2 at the outside of the rubber tread, and turn into their second transverse notch sections 3a, 13a that extend beyond the rubber tread edges at an angle that deviates only slightly from the lateral direction.

The rubber tread areas are structured such that the two halves of the rubber tread, are divided into base pitches L1, L2, K1, K2 by one each of the grooves 2 being completely integrated into a base pitch L1, L2, K1, K2 in a certain manner.

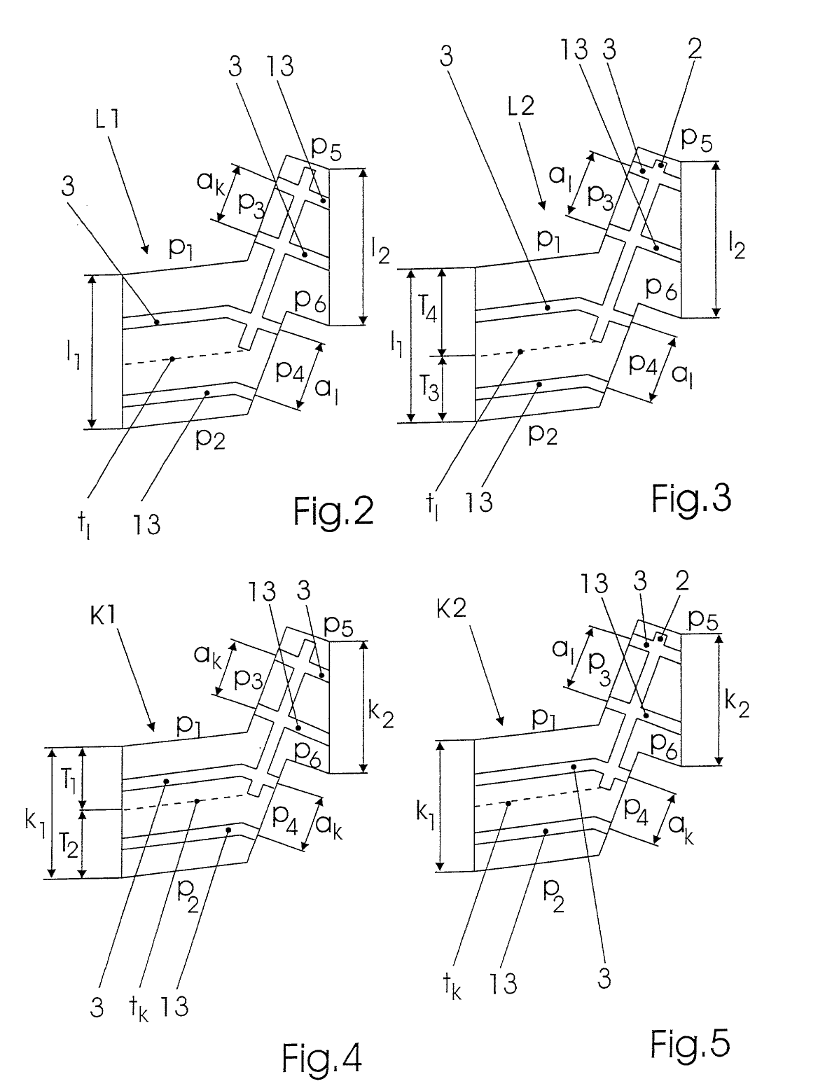

The individual base pitches L1, L2, and K1, K2 are embodied congruently in pairs, with the pairs L1, L2 and K1, K2 differing from one another by their circumferential extent. The base pitches L1, L2 have a greater circumferential extent and/or circumferential length than the base pitches K1, K2. The circumferential extent in the base pitches L1, L2 and K1, K2 is determined by two pitch limit sections p₁, p₂, and/or k₁, k₂ each, extending in the circumferential direction of the rubber tread profile, with p₁ and k₁ each running adjacent to the rubber tread edge and p₂, k₂ each adjacent to the circumferential notch 1. Here, p₂>k₂ and p₁>k₁ with these being the only pitch limit sections in which the longer base pitches L1, L2 differ from the shorter base pitches K1, K2. The progression of the further pitch limit sections identical for all base pitches L1, L2 and/or K1, K2, is discussed using the base pitch L1 shown in FIG. 2.

The pitch limit sections p₁, p₂ that are adjacent to the pitch limit section p₁ run parallel to one another and parallel to those transverse notch sections 3a, 13a of the two transverse notches 3, 13 adjacent to one another and enclosed between them. Limit sections p₃, p₄, which are the same length on the inside of the rubber tread, join the pitch limit sections p₁ and p₂. Limit sections p₃, p₄, run parallel to one another and parallel to grooves 2. Here, the pitch limit sections p₃ and p₄ each divide two transverse notch sections 3b, 13b adjacent to one another. Pitch limit sections P₅, P₆, likewise running parallel to one another and equal in length, follow the pitch limit sections p₃, p₄ and are oriented essentially parallel to the transverse notch sections 3b, 13b and extend to the circumferential notch 1. Each groove 2 in a base pitch L1, L2 is thus surrounded and/or enclosed by pitch limit sections p₁, p₃, p₅, p₂, P₆, and p₄. In a base pitch K1, K2, the shorter circumferential lengths k₁ and k₂ replace the circumferential lengths p₁ and p₂.

In each short base pitch K₁, K₂ and in each base pitch L1, L2 the reciprocal interval of the transverse notch sections 3a and 13a each correspond in the area between the pitch limit sections p₁ and p₂ and their progression as well. Here, the reciprocal interval of the transverse notch sections 3a and 13a in the shorter base pitches K1, K2 is selected to be shorter than in the two longer base pitches L1, L2. At the pitch limit section p₄, where the transverse notch sections 3b, 13 are divided, the reciprocal interval is each aₖ in a base pitch K1, K2, and each a in a base pitch L1, L2. Those parts of the transverse notch sections 3b, 13b that run between the pitch limit sections p₁ and p₃ (in the base pitches L1, L2) and/or k₁ and p₃ (in the base pitches K1, K2) have a mutual distance at the pitch limit sections p₃ which is aₖ each at a base pitch K1, a₁ each at a base pitch K₂, aₖ each at a base pitch L1, and a₁ each at a base pitch L2. This special development allows very specific combinations of the sequence of base pitches L1, L2, K1, K2 over the tire circumference. Only a base pitch K2 or L2 can follow each long base pitch L1 or L2, only a base pitch K1 or L1 can follow each short base pitch K1 or K2.

Furthermore, partial pitches, with circumferential lengths T₁, T₂ (in the base pitches K1, K2) and/or T₃, T₄ (in the base pitches L1, L2), are formed between the pitch limit sections p₁, p₂ in each long base pitch L1, L2 and in each short base pitch K1, K2; these partial pitches are drawn with the dividing lines t₁ and tₖ drawn in a broken line. The circumferential lengths T₁ through T₄ measured at the edge of the rubber tread are selected such that T1<T2 and T3<T4. The partial pitches of the circumferential lengths T1 and T4 each adjoin a pitch limit section p₁.

The worst case of a partial pitch of the length T₄ directly following a partial pitch of the length T₁ is ruled out by the adjustment of the intervals aₖ and a₁.

The sequence of pitches, the succession of the individual base pitches K1, K2, L1, L2 over the circumference of the tire can be determined by calculation, allowing for an advantageous rolling noise and adhering to the above-mentioned conditions that only a base pitch K1, L2 can follow each base pitch L1, L2 and only a base pitch K1 or L1 can follow each base pitch K1, K2.

The invention is not limited to the exemplary embodiment shown. The invention can also be applied to differently embodied profiles, in so far as any primary profile structures are provided running at a comparatively small angle to the circumferential direction, which are crossed by secondary profile structures or into which secondary profile structures open. Further, embodiments are possible in which the primary profile structures are crossed by more than three secondary profile structures. In this case, a greater number of different base pitches may be selected, embodied and arranged according to the invention.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A vehicle tire comprising:
a rubber tread profile;
at least one rubber tread area running in a circumferential direction;
primary profile structures arranged in said rubber tread area, said primary profile structures being aligned at an angle deviating up to 40° from the circumferential direction;
secondary profile structures provided in a crossing arrangement in relation to the primary profile structures, wherein the primary and the secondary profile structures form similar pitches of differing circumferential lengths in the circumferential direction, wherein at least two types of base pitches are provided, a first of the at least two types of base pitches differing from a second of the at least two types of base pitches by their various circumferential lengths, and wherein the base pitches of one type are identically embodied, whereas the base pitches are embodied differently relative to the progression of their profile structures, wherein each base pitch completely encircles one of the primary profile structures and divides secondary pitch structures at pitch limits, each running for given mutual distances.

2. The vehicle tire according to claim 1, wherein said primary profiles comprise one of ribs and grooves.

3. The vehicle tire according to claim 2, wherein said secondary profiles comprise transverse notches.

4. The vehicle tire according to claim 1, wherein the rubber tread has a center and an edge, at least two of the secondary profile structures being divided at a pitch limit section facing the center of the rubber tread, and at least two of the secondary profile structures being divided at the pitch limit section facing the rubber tread edge.

5. The vehicle tire according to claim 4, wherein a reciprocal interval of at least one of the pitch limit sections facing the rubber tread center of the divided secondary profile structures is identical within one type of base pitches.

6. The vehicle tire according to claim 5, wherein a reciprocal interval of at least one of the secondary profile structures divided at a pitch limit section facing the rubber tread edge is different from the pitch of one type of base pitches, but at least consistent with at least one type of reciprocal interval of the secondary profile structures that are divided at the pitch limit section facing the rubber tread center.

7. The vehicle tire according to claim 6, wherein the pitches belonging to one type of base pitches are divided into two partial pitches, each in a consistent way.

8. The vehicle tire according to claim 7, wherein the primary profile structures comprise grooves and the secondary profile structures comprise transverse notches, wherein, from a circumferential direction, one transverse notch crosses two grooves following one another in the circumferential direction, alternating with a transverse notch that crosses each groove.

9. The vehicle tire according to claim 1, wherein a reciprocal interval of at least one of the secondary profile structures divided at a pitch limit section facing the rubber tread edge is different from the pitch of one type of base pitches, but at least consistent with at least one type of reciprocal interval of the secondary profile structures that are divided at the pitch limit section facing the rubber tread center.

10. The vehicle tire according to claim 1, wherein the pitches belonging to one type of base pitches are divided into two partial pitches, each in a consistent way.

11. The vehicle tire according to claim 1, wherein the primary profile structures comprise grooves and the secondary profile structures comprise transverse notches, wherein, from a circumferential direction, one transverse notch crosses two grooves following one another in the circumferential direction, alternating with a transverse notch that crosses each groove.

12. The vehicle tire according to claim 4, wherein a reciprocal interval of at least one of the secondary profile structures divided at a pitch limit section facing the rubber tread edge is different from the pitch of one type of base pitches, but at least consistent with at least one type of reciprocal interval of the secondary profile structures that are divided at the pitch limit section facing the rubber tread center.

13. The vehicle tire according to claim 4, wherein the pitches belonging to one type of base pitches are divided into two partial pitches, each in a consistent way.

14. The vehicle tire according to claim 4, wherein the primary profile structures comprise grooves and the secondary profile structures comprise transverse notches, wherein, from a circumferential direction, one transverse notch crosses two grooves following one another in the circumferential direction, alternating with a transverse notch that crosses each groove.

15. The vehicle tire according to claim 5, wherein a reciprocal interval of at least one of the secondary profile structures divided at a pitch limit section facing the rubber tread edge is different from the pitch of one type of base pitches, but at least consistent with at least one type of reciprocal interval of the secondary profile structures that are divided at the pitch limit section facing the rubber tread center.

16. The vehicle tire according to claim 5, wherein the pitches belonging to one type of base pitches are divided into two partial pitches, each in a consistent way.

17. A vehicle tire comprising:
a rubber tread profile;
at least one rubber tread area running in a circumferential direction;
primary profile structures comprising one of ribs and grooves, said primary profile structures arranged in said rubber tread area, and being aligned at an angle deviating up to 40° from the circumferential direction;
secondary profile structures comprising transverse notches provided in a crossing arrangement in relation to the primary profile structures, wherein the primary and the secondary profile structures form similar pitches of differing circumferential lengths in the circumferential direction, wherein at least two types of base pitches are provided, a first of the at least two types of base pitches differing from a second of the at least two types of base pitches by their various circumferential lengths, and wherein the base pitches of one type are identically embodied, whereas the base pitches are embodied differently relative to the progression of their profile structures, wherein each base pitch completely encircles one of the primary profile structures and divides secondary pitch structures at pitch limits, each running for given mutual distances;
the rubber tread having a center and an edge, at least two of the secondary profile structures being divided at a pitch limit section facing the center of the rubber tread, and at least two of the secondary profile structures being divided at the pitch limit section facing the rubber tread edge,
wherein a reciprocal interval of at least one of the pitch limit sections facing the rubber tread center of the divided secondary profile structures is identical within one type of base pitches,
wherein a reciprocal interval of at least one of the secondary profile structures divided at a pitch limit section facing the rubber tread edge is different from the pitch of one type of base pitches, but at least consistent with at least one type of reciprocal interval of the secondary profile structures that are divided at the pitch limit section facing the rubber tread center,
wherein the pitches belonging to one type of base pitches are divided into two partial pitches, each in a consistent way and
wherein, from a circumferential direction, one transverse notch crosses two grooves following one another in the circumferential direction, alternating with a transverse notch that crosses each groove.
